(19) United States
(12) Patent Application Publication
(10) Pub. No.: US 2026/0085815 A1
(43) Pub. Date: Mar. 26, 2026

(54) LIGHTING DEVICE

(71) Applicant: Japan Display Inc., Tokyo (JP)

(72) Inventor: Daisuke HAMANO, Tokyo (JP)

(21) Appl. No.: 19/408,540

(22) Filed: Dec. 4, 2025

Related U.S. Application Data
(63) Continuation of application No. PCT/JP2024/017588, filed on May 13, 2024.

(30) Foreign Application Priority Data
Jul. 5, 2023 (JP) 2023-110578

(51) Int. Cl. F21V 14/00; F21V 23/04

(52) U.S. Cl. CPC F21V 14/003; F21V 23/04

(57) ABSTRACT

A lighting device includes a light source, an optical element including a liquid crystal cell and transmitting light emitted from the light source in a diffusible manner, a main body incorporating the light source and the optical element and irradiating the light that passes through the optical element, and a first slide switch including a first knob that is slidably operated relative to the main body and that adjusts a light distribution angle of the light irradiated from the main body by sliding the first knob.

### CROSS-REFERENCE TO RELATED APPLICATIONS

This application is a Continuation of International Patent Application No. PCT/JP2024/017588, filed on May 13, 2024, which claims the benefit of priority to Japanese Patent Application No. 2023-110578, filed on July 5, 2023, the entire contents of which are incorporated herein by reference.

### FIELD

An embodiment of the present invention relates to a lighting device that controls light distribution using a liquid crystal.

### BACKGROUND

When a portable lighting device, a so-called flashlight, can not only irradiate light in a predetermined direction but also have the function of changing a light distribution of the irradiated light, the additional value of the product is increased. For example, Japanese laid-open patent publication No. 2009-9946 discloses a flashlight that can distribute light by using a reflector to change the focal length of the light bulb, which is the light source of the flashlight.

### SUMMARY

A lighting device according to an embodiment of the present invention includes a light source, an optical element including a liquid crystal cell and transmitting light emitted from the light source in a diffusible manner, a main body incorporating the light source and the optical element and irradiating the light that passes through the optical element, and a first slide switch including a first knob that is slidably operated relative to the main body and that adjusts a light distribution angle of the light irradiated from the main body by sliding the first knob.

### BRIEF DESCRIPTION OF DRAWINGS

FIG. 1A is a schematic side view showing an exterior configuration of a lighting device according to an embodiment of the present invention.

FIG. 1B is a schematic top view showing an exterior configuration of a lighting device according to an embodiment of the present invention.

FIG. 2A is a schematic diagram illustrating an operation and a light distribution of a lighting device according to an embodiment of the present invention.

FIG. 2B is a schematic diagram illustrating an operation and a light distribution of a lighting device according to an embodiment of the present invention.

FIG. 2C is a schematic diagram illustrating an operation and a light distribution of a lighting device according to an embodiment of the present invention.

FIG. 2D is a schematic diagram illustrating an operation and a light distribution of a lighting device according to an embodiment of the present invention.

FIG. 3 is a schematic block diagram showing an internal configuration of a lighting device according to an embodiment of the present invention.

FIG. 4A is a schematic cross-sectional view showing a configuration of an optical element of a lighting device according to an embodiment of the present invention.

FIG. 4B is a schematic cross-sectional view showing a configuration of an optical element of a lighting device according to an embodiment of the present invention.

FIG. 5A is a schematic plan view showing an electrode pattern of a liquid crystal cell included in an optical element of a lighting device according to an embodiment of the present invention.

FIG. 5B is a schematic plan view showing an electrode pattern of a liquid crystal cell included in an optical element of a lighting device according to an embodiment of the present invention.

FIG. 6A is a schematic diagram illustrating optical characteristics of a liquid crystal cell included in an optical element of the lighting device according to an embodiment of the present invention.

FIG. 6B is a schematic diagram illustrating optical characteristics of a liquid crystal cell included in an optical element of the lighting device according to an embodiment of the present invention.

FIG. 7 is a schematic diagram showing signals input to an optical element of a lighting device according to an embodiment of the present invention.

FIG. 8 is a schematic side view showing an external configuration of a lighting device according to an embodiment of the present invention.

### DESCRIPTION OF EMBODIMENTS

In Japanese laid-open patent publication No. 2009-9946, a reflector disposed in a head cover moves relative to a bulb when a bezel engaged with the head cover is rotated. In other words, when a user rotates the bezel, which is engaged with the head cover where an optical element including the reflector of the flashlight is disposed, the distribution of light irradiated from the flashlight is changed. However, in the case of the flashlight disclosed in Japanese laid-open patent publication No. 2009-9946, the user must hold the flashlight with one hand while operating the bezel with the other hand. Such operation is not necessarily convenient and reduces user operability.

On the other hand, an optical element which is a so-called liquid crystal lens has been conventionally known in which a change in the reflective index of a liquid crystal is utilized by adjusting a voltage applied to the liquid crystal. In a lighting device using a liquid crystal lens, it is possible to change a light distribution of the lighting device without changing the focal length of a light source.

An embodiment of the present invention can provide a lighting device that has a high user operability and allows a light distribution to be easily adjusted.

In the following description, each of the embodiments of the present invention is described with reference to the drawings. However, the present invention can be implemented in various modes without departing from the gist of the invention and should not be interpreted as being limited to the description of the embodiments exemplified below.

Although the drawings may be schematically represented in terms of width, thickness, shape, and the like of each part as compared with their actual mode in order to make explanation clearer, they are only an example and an interpretation of the present invention is not limited. In addition, in the drawings, the same reference numerals are provided to the same elements as those described previously with reference to preceding figures and repeated explanations may be omitted accordingly.

In the case when a single film is processed to form a plurality of structural bodies, each structural body may have different functions and roles, and the bases formed beneath each structural body may also be different. However, the plurality of structural bodies is derived from films formed in the same layer by the same process and have the same material. Therefore, the plurality of these films is defined as existing in the same layer.

When expressing a mode in which another structure is arranged over a certain structure, in the case where it is simply described as “over”, unless otherwise noted, a case where another structure is arranged directly over a certain structure as if in contact with that structure, and a case where another structure is arranged via yet another structure over a certain structure, are both included.

### First Embodiment

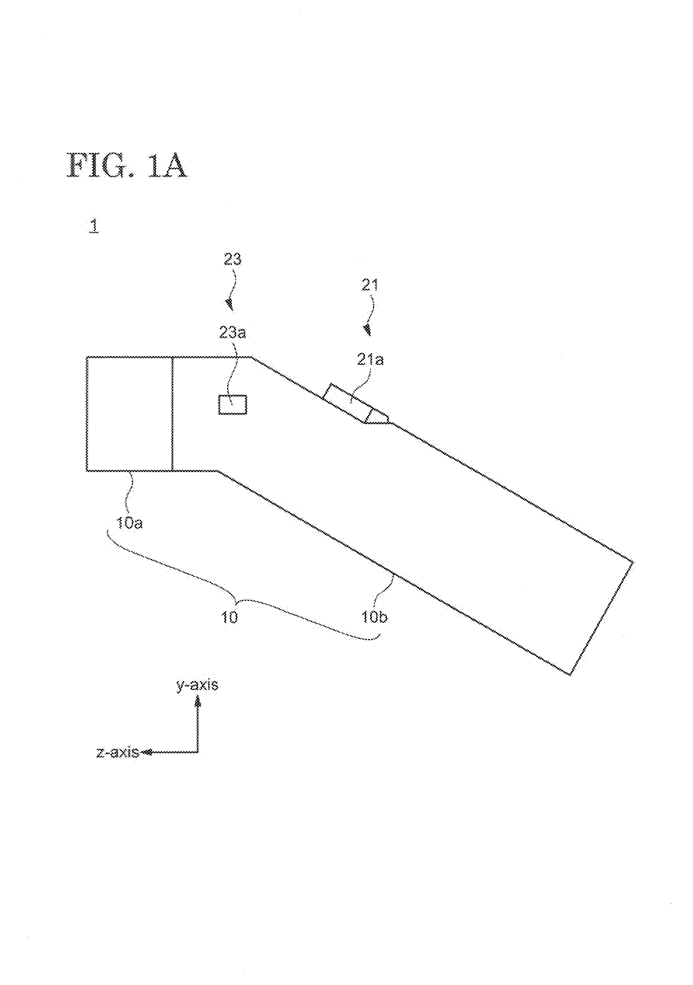

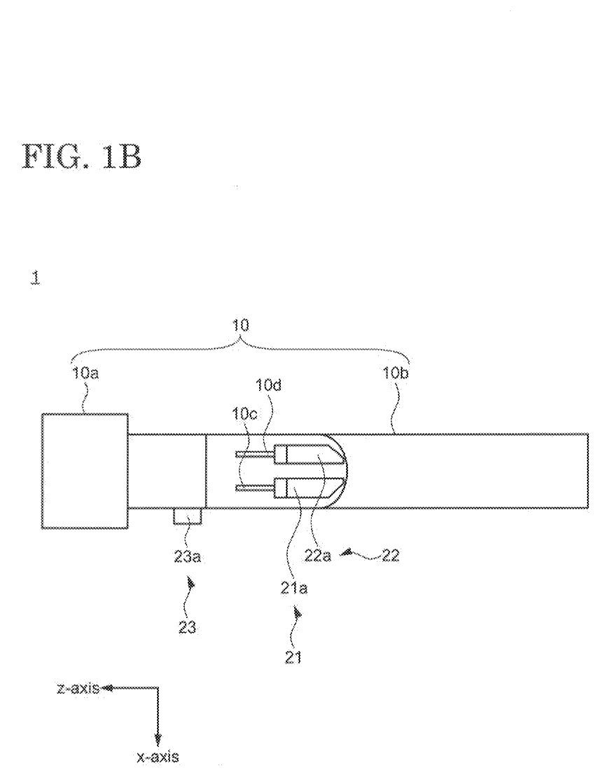

A lighting device 1 according to an embodiment of the present invention is described with reference to FIGS. 1A to 6.

### 1. External Configuration of Lighting Device 1

FIGS. 1A and 1B are a schematic side view and a schematic top view, respectively, showing an external configuration of the lighting device 1 according to an embodiment of the present invention.

As shown in FIGS. 1A and 1B, an exterior of the lighting device 1 is configured by a main body 10. The main body 10 includes a lighting unit 10a that irradiates light and a handle unit 10b that is connected to the lighting unit 10a and is held by a user. The lighting device 1 can be used as a flashlight. That is, the user can illuminate their surroundings with light irradiated from the lighting unit 10a while holding the handle unit 10b. In addition, the usage of the lighting device 1 is not limited to a flashlight. The lighting device 1 can also be used as a spotlight.

Hereinafter, for convenience of explanation, it is described that an optical axis direction of light emitted from the lighting unit 10a is a z-axis direction. Further, although a light irradiation direction is the +z-axis direction, the description simply refers to the z-axis direction when there is no need to distinguish between the +z-axis direction and the -z-axis direction. An x-axis direction and a y-axis direction are perpendicular to the z-axis direction, and the x-axis direction and the y-axis direction are perpendicular to each other.

In a side view, the handle unit 10b extends at a predetermined angle from the z-axis direction. In other words, the handle axis direction, which corresponds to the extension direction of the handle unit 10b, is different from the optical axis direction. When the lighting unit 10a and the handle unit 10b are connected to each other in a bent manner, even when a user uses the lighting device 1 near the user's face, the user can grasp the handle unit 10b without applying excessive force to the user's wrist, and the light irradiated from the lighting unit 10a can illuminate the user's surroundings. In addition, although the predetermined angle is 15 degrees to 45 degrees, the predetermined angle is not limited thereto. Further, the shape of the main body 10 is not limited thereto. The main body 10 can have a shape that depends on the usage aspect of the lighting device 1.

The material that constitutes the main body 10 may be a resin material or a metal material.

The lighting device 1 includes a first slide switch 21 for adjusting the light distribution angle of the light irradiated from the lighting unit 10a, a second slide switch 22 for adjusting the brightness of the light irradiated from the lighting unit 10a, and a changeover switch 23 for switching the light distribution pattern of the light irradiated from the lighting unit 10a. The first slide switch 21 includes a first knob 21a operated by a user. The second slide switch 22 includes a second knob 22a operated by a user. The changeover switch 23 includes a push button 23a operated by a user.

The first knob 21a of the first slide switch 21 and the second knob 22a of the second slide switch 22 are provided on an upper surface of the handle unit 10b, on the side where the handle unit 10b is connected to the lighting unit 10a. The first knob 21a and the second knob 22a are arranged in a direction intersecting the handle axis direction. The upper surface of the handle unit 10b is provided with a first guide groove 10c and a second guide groove 10d extending along the handle axis direction. The first knob 21a and the second knob 22a are slidably fitted into the first guide groove 10c and the second guide groove 10d, respectively. That is, the first knob 21a is operated to slide in the handle axis direction along the first guide groove 10c, and the second knob 22a is operated to slide in the handle axis direction along the second guide groove 10d. Since the first slide switch 21 and the second slide switch 22 have this configuration, for example, the user can operate both the first knob 21a and the second knob 22a using only the thumb of the hand holding the handle unit 10b.

The push button 23a of the changeover switch 23 is provided on the side of the handle unit 10b. The changeover switch 23 is a so-called push switch. The changeover switch 23 may be a momentary type that maintains an on-state only while the push button 23a is pressed, or an alternate type that maintains an on-state even after the push button 23a is pressed and released. Further, the changeover switch 23 is not limited to a push switch. The changeover switch 23 may also be a toggle switch, a rocker switch, a slide switch, or the like.

In addition, the positions of the first knob 21a of the first slide switch 21, the second knob 22a of the second slide switch 22, and the push button 23a of the changeover switch 23 are not limited to the above-described configuration. The first knob 21a and the second knob 22a may be arranged on the side surface of the handle 10b, and the push button 23a may be arranged on the top surface of the handle 10b.

Further, although not shown in the figures, a switch may be provided to turn on or off the power supply of the lighting device 1. Alternatively, a configuration in which the power supply of the lighting device 1 can be turned on or off by a changeover switch 23 may also be applied.

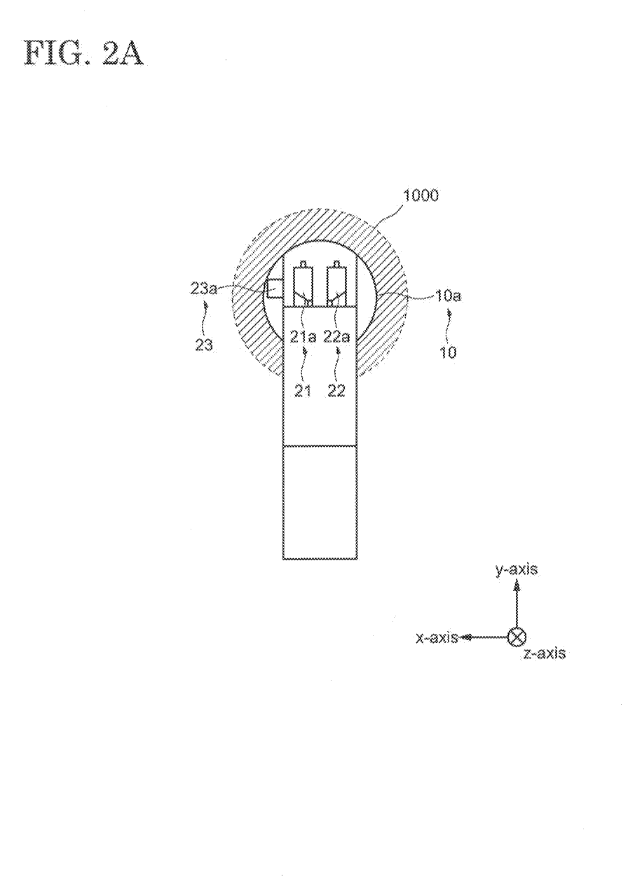

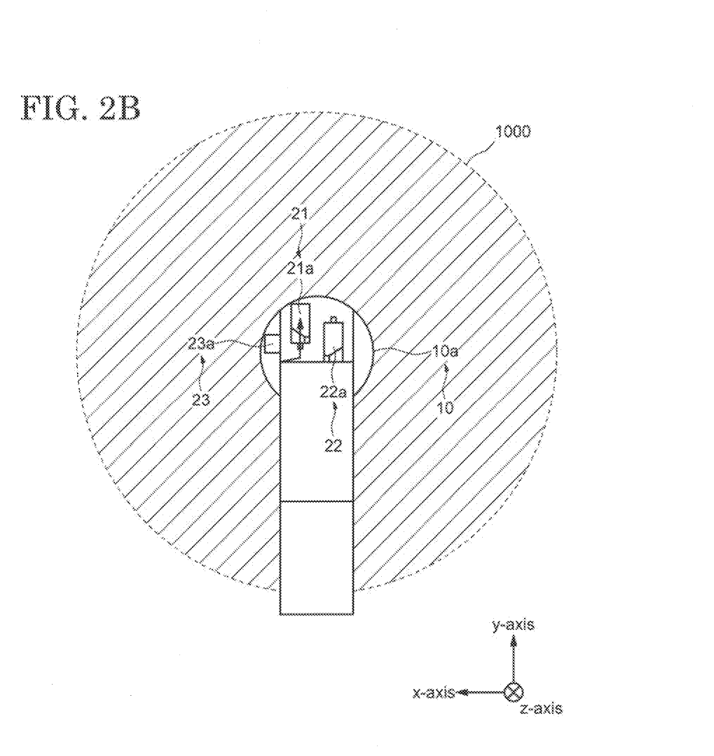

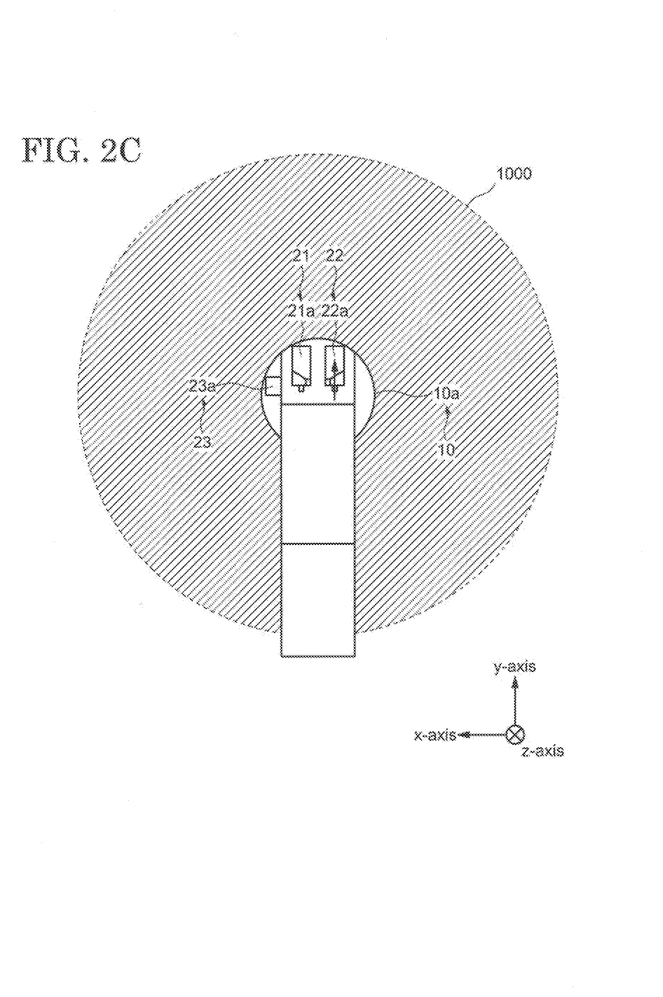

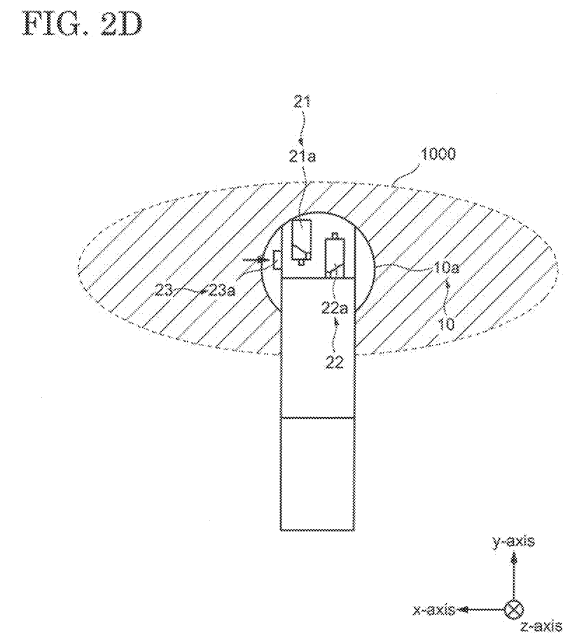

Here, a change in a light distribution due to operation of the lighting device 1 is described with reference to FIGS. 2A to 2D.

FIGS. 2A to 2D are schematic diagrams illustrating an operation and a light distribution of the lighting device 1 according to an embodiment of the present invention.

In FIG. 2A, the first knob 21a of the first slide switch 21 and the second knob 22a of the second slide switch 22 are located in the region farthest from the lighting unit 10a within their respective slidable ranges. In this case, light 1000 irradiated from the lighting unit 10a has a circular light distribution pattern.

As shown in FIG. 2B, when the first knob 21a of the first slide switch 21 is slid, the light 1000 irradiated from the lighting unit 10a gradually spreads in the x-axis direction and the y-axis direction. That is, the light distribution angle of the light 1000 irradiated from the lighting unit 10a increases. Thus, the light distribution angle of the light 1000 irradiated from the lighting unit 10a can be continuously adjusted by sliding the first knob 21a of the first slide switch 21.

In the lighting device 1, when the light distribution angle of the light 1000 irradiated from the lighting unit 10a increases, the brightness of the light 1000 decreases. Therefore, the brightness of the light 1000 is adjusted using the second slide switch 22.

As shown in FIG. 2C, when the second knob 22a of the second slide switch 22 is further slid, the brightness of the light 1000 irradiated from the lighting unit 10a gradually increases. Thus, the brightness of the light 1000 irradiated from the lighting unit 10a can be continuously adjusted by sliding the second knob 22a of the second slide switch 22.

In FIGS. 2A to 2C, when the first knob 21a of the first slide switch 21 is located in the region farthest from the lighting unit 10a within its slidable range, the light distribution angle of the light 1000 is minimum, and when the first knob 21a is located in the region closest to the lighting unit 10a within its slidable range, the light distribution angle of the light 1000 is maximum. However, the sliding operation of the first knob 21a to adjust the light distribution angle of the light 1000 may be reversed from the above-described configuration. Further, when the second knob 22a of the second slide switch 22 is located in the region farthest from the lighting unit 10a within its slidable range, the brightness of the light 1000 is minimum, and when the second knob 22a is located in the region closest to the lighting unit 10a within its slidable range, the brightness of the light 1000 is maximum. However, the sliding operation of the second knob 22a to adjust the brightness of the light 1000 may be reversed from the above-described configuration.

As described above, the first slide switch 21 can be used to adjust the light distribution angle of the light 1000 irradiated from the lighting unit 10a in the lighting device 1. Further, the second slide switch 22 can be used to adjust the brightness of the light 1000 irradiated from the lighting unit 10a in the lighting device 1. Furthermore, in the lighting device 1, the user can slide the first knob 21a of the first slide switch 21 and the second knob 22a of the second slide switch 22 with a finger (e.g., a thumb) of the hand holding the handle 10b while holding the handle 10b. Therefore, the user can adjust the light distribution angle and the brightness of the light 1000 irradiated from the lighting unit 10a with a simple operation using one hand. Further, since the light distribution angle and the brightness of the light 1000 change continuously, the user can fine-tune the light distribution angle and the brightness of the light 1000.

Further, in the lighting device 1, the light distribution can be controlled not only by adjusting the light distribution angle but also by switching the light distribution shape.

In FIG. 2D, after the first knob 21a of the first slide switch 21 is slid, the push button 23a of the changeover switch 23 is pressed. In this case, the light 1000 irradiated from the lighting unit 10a has a linear light distribution shape extending in the x-axis direction. In this way, the light distribution shape of the light 1000 irradiated from the lighting unit 10a can be switched by operating the push button 23a of the changeover switch 23.

In addition, although the circular or linear light distribution shape is described above, the light distribution shape that can be switched by the changeover switch 23 is not limited thereto. The light 1000 irradiated from the lighting unit 10a may have an elliptical or cross-shaped light distribution shape.

### 2. Internal Configuration of Lighting Device 1

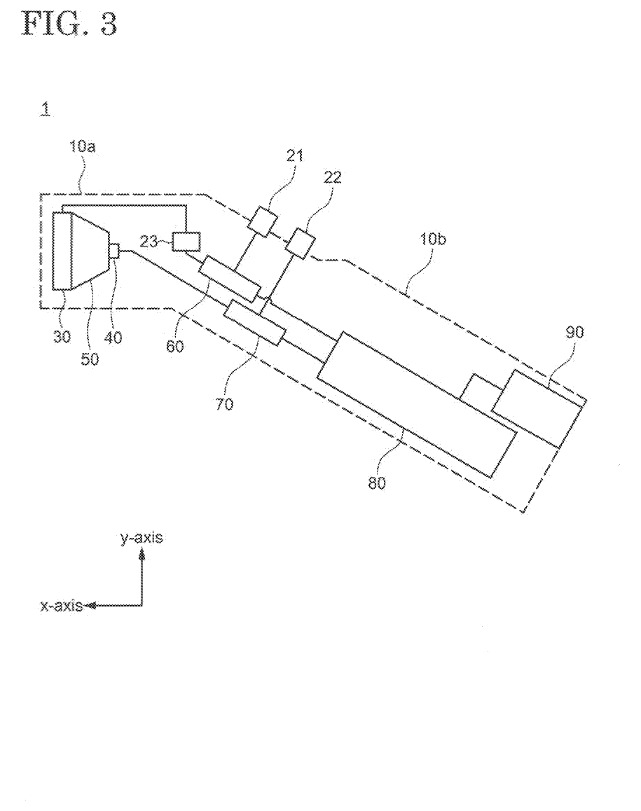

FIG. 3 is a schematic block diagram showing an internal configuration of the lighting device 1 according to an embodiment of the present invention.

As shown in FIG. 3, an optical element 30, a light source 40, an optical adjustment portion 50, an optical element drive circuit portion 60, a light source drive circuit portion 70, a battery 80, and a charging module 90 are housed in the main body 10 of the lighting device 1. The optical element 30, the light source 40, and the optical adjustment portion 50 are disposed in the lighting unit 10a of the main body 10. The battery 80 and the charging module 90 are disposed in the handle unit 10b of the main body 10. Although FIG. 3 shows that the optical element drive circuit portion 60 and the light source drive circuit portion 70 are disposed in the handle unit 10b, the optical element drive circuit portion 60 and the light source drive circuit portion 70 may also be disposed in the lighting unit 10a.

In the lighting device 1, light emitted from the light source 40 passes through the optical element 30 and is irradiated from the lighting unit 10a.

The optical element driving circuit portion 60 is electrically connected to the battery 80 and to the optical element 30 via the changeover switch 23. The optical element driving circuit portion 60 receives power from the battery 80 and generates a plurality of signals (e.g., pulse signals including rectangular waves) that drive the optical element 30. The plurality of signals generated by the optical element driving circuit portion 60 are input to terminals of the optical element 30 selected by the changeover switch 23. Further, the optical element driving circuit portion 60 is electrically connected to the first slide switch 21. Specifically, the first slide switch 21 is electrically connected to a variable resistor in the optical element driving circuit portion 60, and when the first knob 21a of the first slide switch 21 is slid, the resistance of the variable resistor changes continuously. In this way, the amplitude of the potentials included in the plurality of signals can be continuously changed.

The light source drive circuit portion 70 is electrically connected to the light source 40 and the battery 80. The light source drive circuit portion 70 receives power from the battery 80 and generates a signal to drive the light source 40. Further, the light source drive circuit portion 70 is electrically connected to the second slide switch 22. Specifically, the second slide switch 22 is electrically connected to a variable resistor in the light source drive circuit, and when the second knob 22a of the second slide switch 22 is slid, the resistance of the variable resistor changes continuously. In this way, the amount of current included in the signal can be continuously changed.

The battery 80 is electrically connected to the charging module 90. The battery 80 may be a so-called secondary battery (e.g., a lithium-ion battery) that can be repeatedly used by charging. The battery 80 can be charged via the charging module 90. The charging module 90 controls the charging of the battery 80 while preventing overcharging of the battery 80. The battery 80 may be charged either wired or wirelessly. In a wired configuration, the charging module 90 is provided with a terminal for connecting a power cable, and power is charged to the battery 80 via the power cable connected to the terminal of the charging module 90. Further, in a wireless configuration, a power receiving coil is provided in the charging module 90, and power converted by the power receiving coil is charged to the battery 80. In addition, the lighting device 1 may also be configured without the charging module 90. In this case, the battery 80 may be a so-called primary battery (e.g., an alkaline battery or a manganese battery) that cannot be recharged.

The light source 40 emits light to the optical element 30. For example, a light emitting diode (LED) can be used as the light source 40. A plurality of LEDs may be used as the light source 40. When a plurality of LEDs is used as the light source 40, LEDs of the same color may be used, or LEDs of different colors may be used. In addition, the light source 40 is not limited to an LED. The light source 40 may be any element or device that can emit light.

The optical adjusting portion 50 is disposed between the optical element 30 and the light source 40, and converges, diffuses, or reflects the light emitted from the light source 40. For example, the optical adjusting portion 50 is an optical member such as a lens or a reflector, or an optical member in a combination thereof.

### 3. Configuration of Optical Element 30

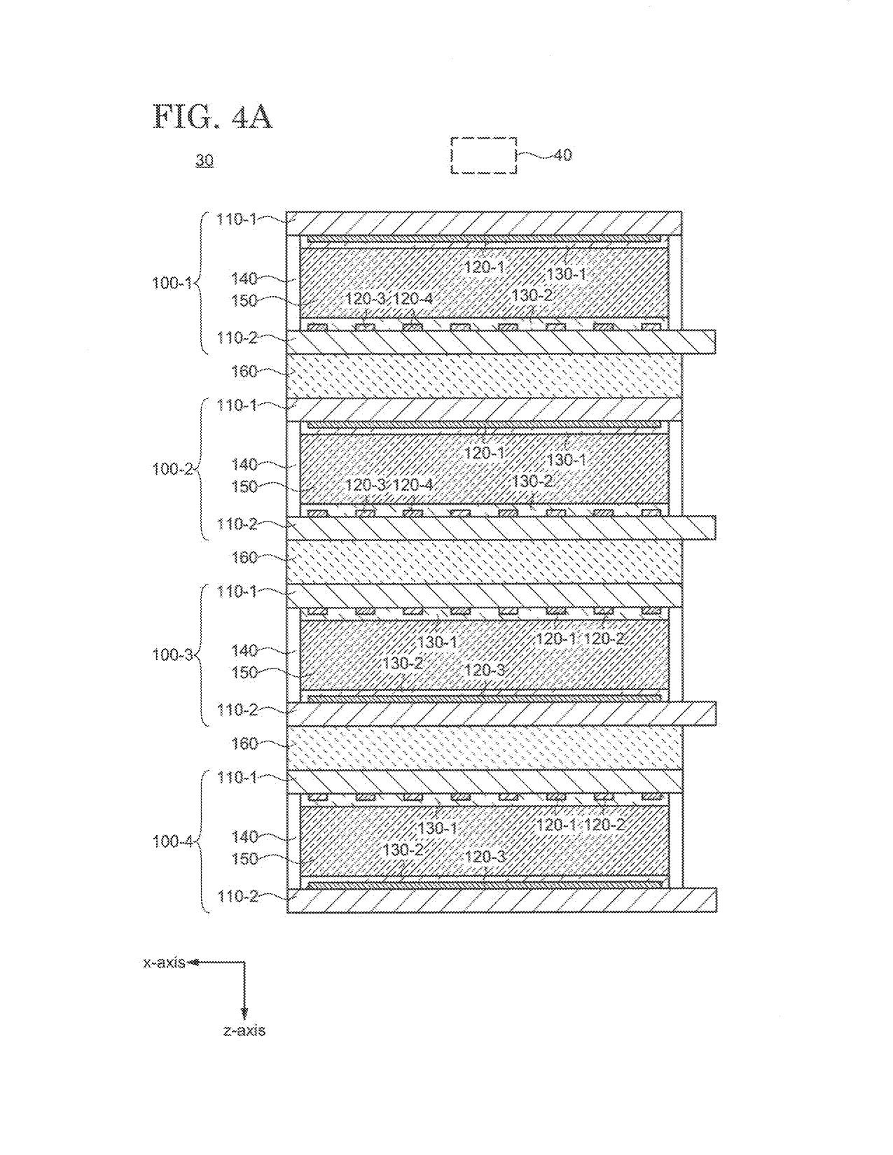

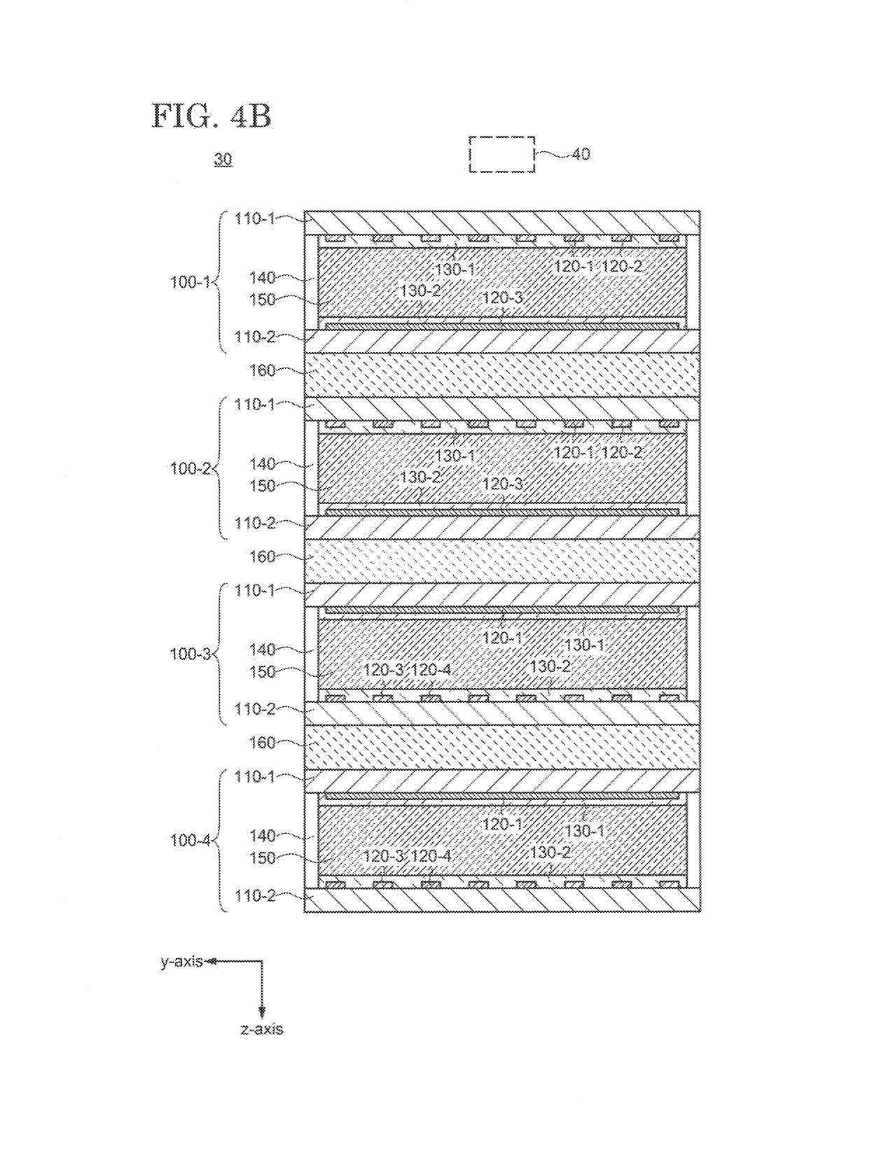

The optical element 30 controls the light distribution (light distribution angle and light distribution shape) of the light emitted from the lighting unit 10a. Here, a configuration of the optical element 30 is described with reference to FIGS. 4A to 6B.

### 3-1. Structure of Optical Element 30

FIGS. 4A and 4B are schematic cross-sectional views showing a configuration of the optical element 30 of the lighting device 1 according to an embodiment of the present invention. FIG. 4A is a cross-sectional view of the optical element 30 taken along a plane perpendicular to the y-axis direction, and FIG. 4B is a cross-sectional view of the optical element 30 taken along a plane perpendicular to the x-axis direction.

The optical element 30 includes four liquid crystal cells 100 (a first liquid crystal cell 100-1, a second liquid crystal cell 100-2, a third liquid crystal cell 100-3, and a fourth liquid crystal cell 100-4). In the optical element 30, the first liquid crystal cell 100-1, the second liquid crystal cell 100-2, the third liquid crystal cell 100-3, and the fourth liquid crystal cell 100-4 are stacked in this order from the side closest to the light source 40 in the z-axis direction. Light emitted from the light source 40 is incident on the first liquid crystal cell 100-1 and is emitted from the fourth liquid crystal cell 100-4. In the lighting device 1, the four liquid crystal cells 100 included in the optical element 30 control the diffusion and the polarization of light, thereby changing the light distribution of the light emitted from the fourth liquid crystal cell 100-4. In other words, the optical element 30 transmits light emitted from the light source 40 in a diffusible manner and can control the light distribution.

Although FIGS. 4A and 4B show the configuration of the optical element 30 including four liquid crystal cells 100, the number of liquid crystal cells 100 included in the optical element 30 is not limited to four. The optical element 30 includes at least one liquid crystal cell 100. However, when irradiating light having various light distribution shapes, it is preferable that the optical element 30 includes at least two liquid crystal cells 100.

As shown in FIGS. 4A and 4B, each of the first liquid crystal cell 100-1 to the fourth liquid crystal cell 100-4 includes a first substrate 110-1, a second substrate 110-2, a plurality of first transparent electrodes 120-1, a plurality of second transparent electrodes 120-2, a plurality of third transparent electrodes 120-3, a plurality of fourth transparent electrodes 120-4, a first alignment film 130-1, a second alignment film 130-2, a sealant 140, and a liquid crystal layer 150. The first transparent electrodes 120-1 and the second transparent electrodes 120-2 are alternately provided on the first substrate 110-1. Further, the first alignment film 130-1 is provided on the first substrate 110-1 so as to cover the first transparent electrodes 120-1 and the second transparent electrodes 120-2. The third transparent electrodes 120-3 and the fourth transparent electrode 120-4 are alternately provided on the second substrate 110-2. Further, the second alignment film 130-2 is provided on the second substrate 110-2 so as to cover the third transparent electrodes 120-3 and the fourth transparent electrodes 120-4. The first substrate 110-1 and the second substrate 110-2 are disposed so that the first transparent electrodes 120-1 and the second transparent electrodes 120-2 face the third transparent electrodes 120-3 and the fourth transparent electrodes 120-4, and are bonded via a sealing member 140 provided on the periphery of the first substrate 110-1 and the second substrate 110-2. A liquid crystal is sealed in a space surrounded by the first substrate 110-1 (more specifically, the first alignment film 130-1), the second substrate 110-2 (more specifically, the second alignment film 130-2), and the sealing member 140, and the liquid crystal layer 150 is provided between the first substrate 110-1 and the second substrate 110-2.

An optical elastic resin layer 160 is provided between the first liquid crystal cell 100-1 and the second liquid crystal cell 100-2. Similarly, optical elastic resin layers 160 are provided between the second liquid crystal cell 100-2 and the third liquid crystal cell 100-3, and between the third liquid crystal cell 100-3 and the fourth liquid crystal cell 100-4. For example, an adhesive containing a light-transmitting acrylic resin can be used for the optical elastic resin layer 160. That is, the optical elastic resin layer 160 can bond and fix two adjacent liquid crystal cells 100 together.

For example, a rigid substrate having light-transmitting properties such as a glass substrate, a quartz substrate, or a sapphire substrate is used as each of the first substrate 110-1 and the second substrate 110-2. Further, a flexible substrate having light-transmitting properties such as a polyimide resin substrate, an acrylic resin substrate, a siloxane resin substrate, or a fluorine resin substrate can also be used as each of the first substrate 110-1 and the second substrate 110-2.

Each of the first transparent electrode 120-1, the second transparent electrode 120-2, the third transparent electrode 120-3, and the fourth transparent electrode 120-4 functions as an electrode for forming an electric field in the liquid crystal layer 150. For example, a transparent conductive material such as indium tin oxide (ITO) or indium zinc oxide (IZO) is used for each of the first transparent electrode 120-1, the second transparent electrode 120-2, the third transparent electrode 120-3, and the fourth transparent electrode 120-4.

In the first liquid crystal cell 100-1 and the second liquid crystal cell 100-2, the first transparent electrode 120-1 and the second transparent electrode 120-2 extend in the x-axis direction, and the third transparent electrode 120-3 and the fourth transparent electrode 120-4 extend in the y-axis direction. In the third liquid crystal cell 100-3 and the fourth liquid crystal cell 100-4, the first transparent electrode 120-1 and the second transparent electrode 120-2 extend in the y-axis direction, and the third transparent electrode 120-3 and the fourth transparent electrode 120-4 extend in the x-axis direction.

In addition, when the first transparent electrode 120-1 to the fourth transparent electrode 120-4 are not particularly distinguished from each other, they may be referred as a transparent electrode 120 in the following description.

Each of the first alignment film 130-1 and the second alignment film 130-2 aligns the liquid crystal molecules in the liquid crystal layer 150 in a predetermined direction. For example, a polyimide resin or the like can be used for each of the first alignment film 130-1 and the second alignment film 130-2. In addition, each of the first alignment film 130-1 and the second alignment film 130-2 may be imparted with alignment properties by an alignment treatment such as a rubbing method or a photo-alignment method. The rubbing method is a method of rubbing the surface of the alignment film in one direction. The photo-alignment method is a method of irradiating an alignment film with linearly polarized ultraviolet rays.

An alignment treatment is performed on the first alignment film 130-1 so that the liquid crystal molecules on the first substrate 110-1 side of the liquid crystal layer 150 are aligned in a direction perpendicular to the extending direction of the first transparent electrode 120-1 and the second transparent electrode 120-2. An alignment treatment is performed on the second alignment film 130-2 so that the liquid crystal molecules on the second substrate 110-2 side of the liquid crystal layer 150 are aligned in a direction perpendicular to the extending direction of the third transparent electrode 120-3 and the fourth transparent electrode 120-4. Therefore, in the first liquid crystal cell 100-1 and the second liquid crystal cell 100-2, the long axes of the liquid crystal molecules on the side of the first substrate 110-1 are aligned in the y-axis direction, and the long axes of the liquid crystal molecules on the side of the second substrate 110-2 are aligned in the x-axis direction. Further, in the third liquid crystal cell 100-3 and the fourth liquid crystal cell 100-4, the long axes of the liquid crystal molecules on the side of the first substrate 110-1 are aligned in the x-axis direction, and the long axes of the liquid crystal molecules on the side of the second substrate 110-2 are aligned in the y-axis direction.

An adhesive material containing epoxy resin or acrylic resin is used for the sealing member 140. The adhesive material may be an ultraviolet curing type or a heat curing type.

The liquid crystal layer 150 can refract transmitted light or change the polarization state of transmitted light in accordance with the alignment state of the liquid crystal molecules. For example, nematic liquid crystal can be used as the liquid crystal of the liquid crystal layer 150. Although a positive liquid crystal is described as the liquid crystal in the present embodiment, a negative liquid crystal can also be adopted by changing the initial alignment directions of the liquid crystal molecules. Further, the liquid crystal preferably contains a chiral agent that imparts twist to the liquid crystal molecules.

### 3-2. Electrode Pattern of Liquid Crystal Cell 100

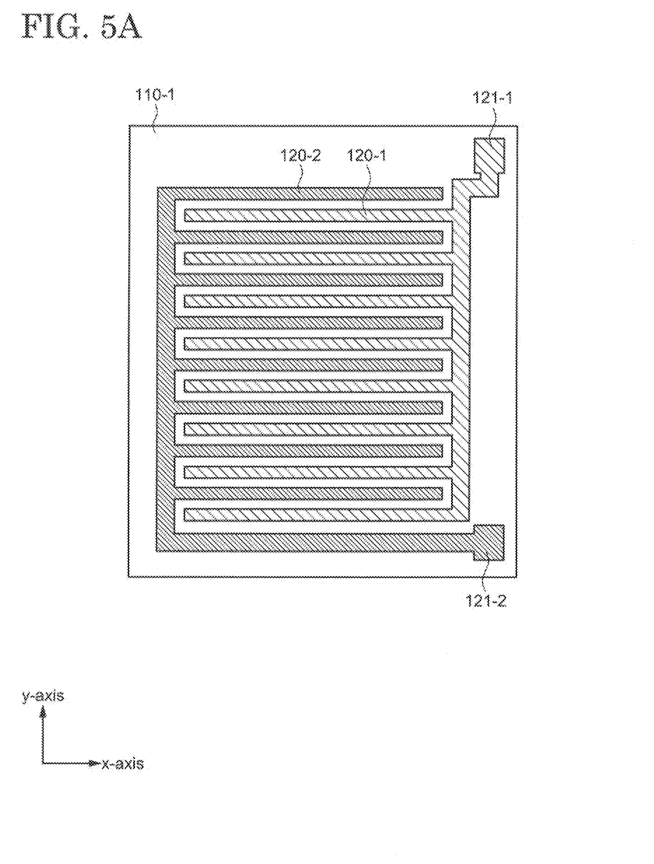

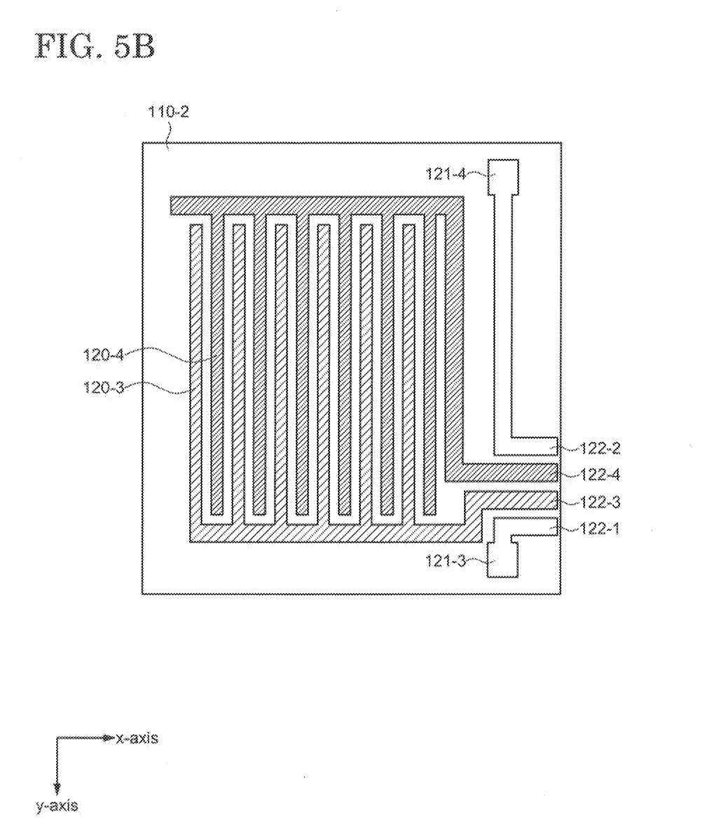

Each of FIGS. 5A and 5B is a schematic plan view showing an electrode pattern of the liquid crystal cell 100 included in the optical element 30 of the lighting device 1 according to an embodiment of the present invention. Specifically, FIG. 5A is a plan view showing an electrode pattern formed on the first substrate 110-1 of the first liquid crystal cell 100-1, and FIG. 5B is a plan view showing an electrode pattern formed on the second substrate 110-2 of the first liquid crystal cell 100-1.

As shown in FIG. 5A, a first connection pad 121-1 and a second connection pad 121-2 are provided on the first substrate 110-1. The plurality of first transparent electrodes 120-1 are electrically connected to the first connection pad 121-1. The plurality of second transparent electrodes 120-2 are electrically connected to the second connection pad 121-2.

As shown in FIG. 5B, a third connection pad 121-3, a fourth connection pad 121-4, a first terminal 122-1, a second terminal 122-2, a third terminal 122-3, and a fourth terminal 122-4 are provided on the second substrate 110-2. The third transparent electrodes 120-3 are electrically connected to the third terminal 122-3. The fourth transparent electrodes 120-4 are electrically connected to the fourth terminal 122-4. The third connection pad 121-3 is electrically connected to the first terminal 122-1. The fourth connection pad 121-4 is electrically connected to the second terminal 122-2.

When the first substrate 110-1 and the second substrate 110-2 are bonded to each other so that the transparent electrodes 120 face each other, the first connection pad 121-1 and the second connection pad 121-2 overlap the third connection pad 121-3 and the fourth connection pad 121-4, respectively. Since a conductive electrode is provided between the first connection pad 121-1 and the third connection pad 121-3, the first connection pad 121-1 and the third connection pad 121-3 are electrically connected via the conductive electrode. Similarly, since a conductive electrode is provided between the second connection pad 121-2 and the fourth connection pad 121-4, the second connection pad 121-2 and the fourth connection pad 121-4 are electrically connected via the conductive electrode. Therefore, the first transparent electrode 120-1 and the second transparent electrode 120-2 on the first substrate 110-1 are electrically connected to the first terminal 122-1 and the second terminal 122-2, respectively.

The electrode pattern of the second liquid crystal cell 100-2 is the same as that of the first liquid crystal cell 100-1. The configurations of the electrode patterns of the third liquid crystal cell 100-3 and the fourth liquid crystal cell 100-4 are similar to that of the first liquid crystal cell 100-1, except that the extending direction of the transparent electrode 120 differs by 90 degrees.

In the liquid crystal cell 100, the first terminal 122-1 to the fourth terminal 122-4 on the second substrate 110-2 are exposed from the first substrate 110-1. In each of the first liquid crystal cell 100-1 to the fourth liquid crystal cell 100-4, the exposed first terminal 122-1 to the fourth terminal 122-4 are electrically connected to the optical element driving circuit portion 60. Although details are described later, a predetermined potential is applied to each of the first transparent electrode 120-1 to the fourth transparent electrode 120-4 of each of the first liquid crystal cell 100-1 to the fourth liquid crystal cell 100-4 when signals generated in the optical element driving circuit portion 60 are input to the first terminal 122-1 to the fourth terminal 122-4 of each of the first liquid crystal cell 100-1 to the fourth liquid crystal cell 100-4. Thus, since the alignment state of the liquid crystal molecules in the liquid crystal layer 150 of each of the first liquid crystal cell 100-1 to the fourth liquid crystal cell 100-4 is changed, the distribution of light passing through the optical element 10 can be changed.

### 3-3. Optical Characteristics of Liquid Crystal Cell 100

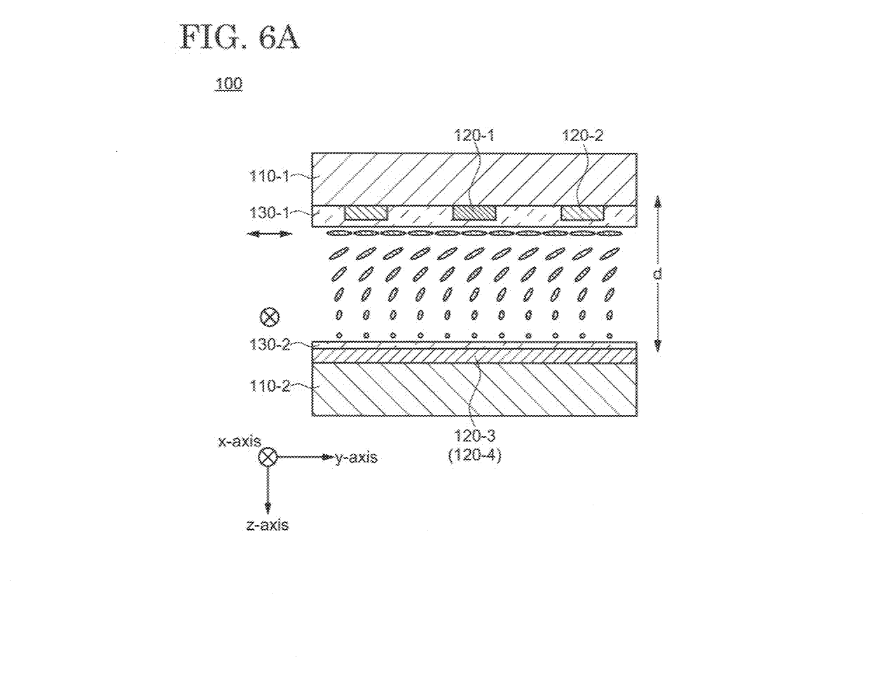

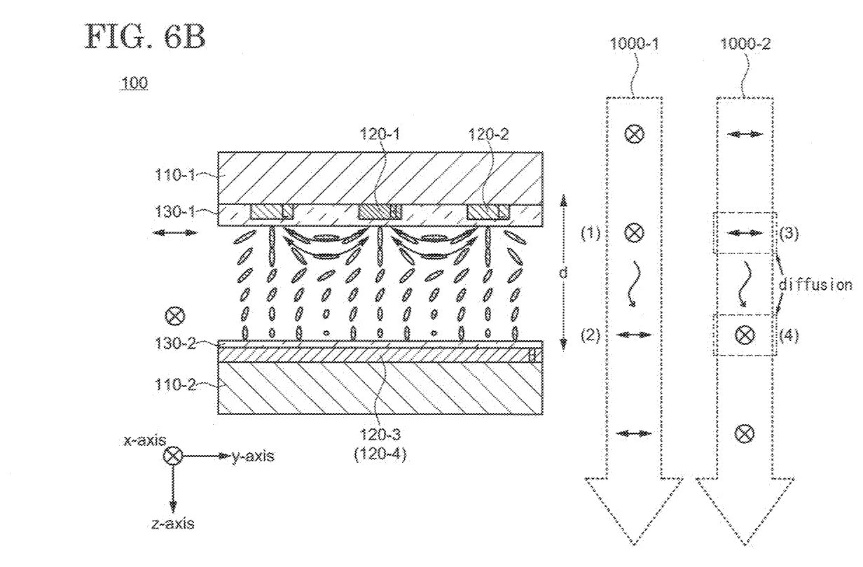

Each of FIGS. 6A and 6B is a schematic diagram illustrating optical characteristics of the liquid crystal cell 100 included in the optical element 30 of the lighting device 1 according to an embodiment of the present invention. Specifically, FIG. 6A shows the liquid crystal cell 100 in a state where no voltage is applied to the transparent electrodes 120, and FIG. 6B shows the liquid crystal cell 100 in a state where voltages are applied to the transparent electrodes 120.

As shown in FIG. 6A, the liquid crystal molecules on the first substrate 110-1 side of the liquid crystal layer 150 are aligned in the y-axis direction, and the liquid crystal molecules on the second substrate 110-2 side of the liquid crystal layer 150 are aligned in the x-axis direction. Therefore, when no voltage is applied to any of the first transparent electrode 120-1 to the fourth transparent electrode 120-4, the liquid crystal molecules in the liquid crystal layer 150 are aligned so as to be twisted 90 degrees as they move from the first substrate 110-1 to the second substrate 110-2. Further, the polarization plane (the direction of the polarization axis or the polarization component) of the light passing through the liquid crystal layer 150 is rotated 90 degrees according to the alignment directions of the liquid crystal molecules. That is, the light passing through the liquid crystal layer 150 (more specifically, the polarization component of the light passing through the liquid crystal layer 150) has optical rotation.

On the other hand, when voltages are applied so that a potential difference is generated between two adjacent transparent electrodes 120, an electric field (hereinafter referred to as a “lateral electric field”) is generated between the two adjacent transparent electrodes 120, and the alignment state of the liquid crystal molecules changes. As shown in FIG. 6B, the liquid crystal molecules in the liquid crystal layer 150 are aligned so as to be twisted 90 degrees from the first substrate 110-1 to the second substrate 110-2, while the liquid crystal molecules closer to the first substrate 110-1 are aligned in a convex arc shape with respect to the first substrate 110-1 by the lateral electric field between the first transparent electrode 120-1 and the second transparent electrode 120-2, and the liquid crystal molecules closer to the second substrate 110-2 are aligned in a convex arc shape with respect to the second substrate 110-2 by the lateral electric field between the third transparent electrode 120-3 and the fourth transparent electrode 120-4. The liquid crystal molecules aligned in the convex arc shape have a refractive index distribution, and the polarization component of light along the alignment direction of the liquid crystal molecules is diffused. In addition, since the cell gap d, which is the distance between the first substrate 110-1 and the second substrate 110-2, is sufficiently larger than the distance between two adjacent transparent electrodes (for example, 10 μm ≤ d ≤ 30 μm, preferably 10 μm ≤ d ≤ 30 μm, and more preferably 15 μm ≤ d ≤ 25 μm), the electric field formed between the transparent electrodes 120 does not have much effect on the liquid crystal molecules located in the vicinity of the center between the first substrate 110-1 and the second substrate 110-2.

The light emitted from the light source 40 includes a polarization component in the x-axis direction (hereinafter, referred to as a “P-polarization component”) and a polarization component in the y-axis direction (hereinafter, referred to as an “S-polarization component”). However, in the following description, it is described that the light incident on the liquid crystal cell 100 is divided into a first light 1000-1 having the P-polarization component and a second light 1000-2 having the S-polarization component, for convenience.

Since the polarization direction of the P-polarized component of the first light 1000-1 incident on the first substrate 110-1 is different from the alignment direction of the liquid crystal molecules on the side of the first substrate 110-1, the first light 1000-1 is not diffused (see (1) in FIG. 6B). Further, the first light 1000-1 is rotated while passing through the liquid crystal layer 150, and the polarization component changes from the P-polarization component to the S-polarization component. Since the polarization direction of the S-polarization component of the first light 1000-1 is different from the alignment direction of the liquid crystal molecules on the side of the second substrate 110-2, the first light 1000-1 is not diffused (see (2) in FIG. 6B).

Since the polarization direction of the S-polarization component of the second light 1000-2 incident on the first substrate 110-1 is the same as the alignment direction of the liquid crystal molecules on the side of the first substrate 110-1, the second light 1000-2 is diffused in the y-axis direction in accordance with the refractive index distribution of the liquid crystal molecules (see (3) in FIG. 6B). Further, the second light 1000-2 is rotated while passing through the liquid crystal layer 150, and the polarization component changes from the S-polarization component to the P-polarization component. Since the polarization direction of the P-polarization component of the second light 1000-2 is the same as the alignment direction of the liquid crystal molecules on the side of the second substrate 110-2, the second light 1000-2 is diffused in the x-axis direction in accordance with the refractive index distribution of the liquid crystal molecules (see (4) in FIG. 6B).

Although the above description is of the configuration of one liquid crystal cell 100, in an optical element 30 including multiple liquid crystal cells 100, each of the plurality of liquid crystal cells 100 controls the P-polarization component or the S-polarization component of the light incident on the optical element 30.

### 3-4. Input of Signal to Liquid Crystal Cell 100

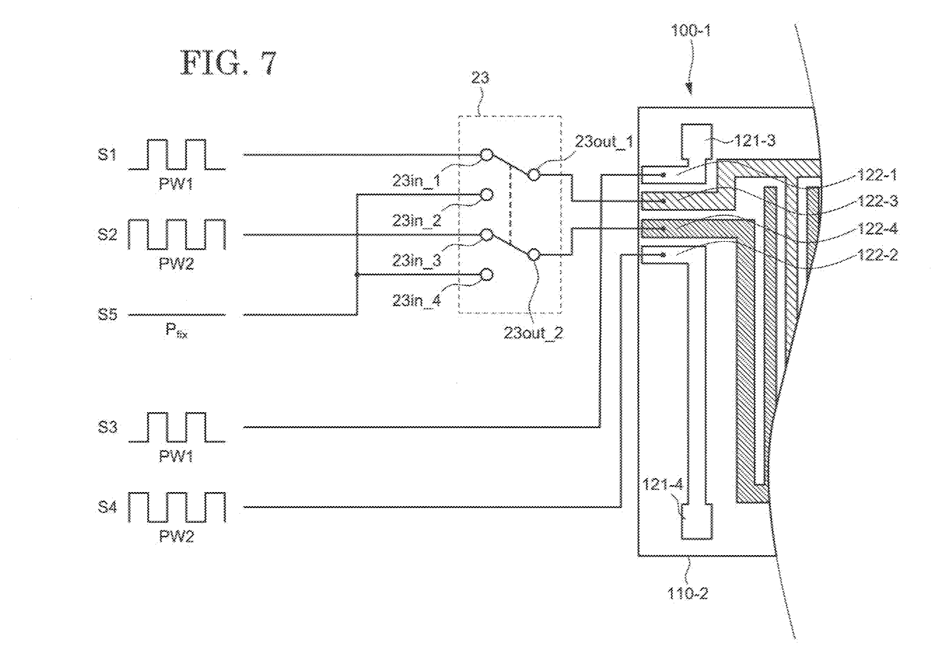

FIG. 7 is a schematic diagram showing signals input to the optical element 30 of the lighting device 1 according to an embodiment of the present invention. FIG. 7 shows the first liquid crystal cell 100-1 of the optical element 30.

FIG. 7 shows a first signal S1 to a fifth signal S5 input to the first liquid crystal cell 100-1 of the optical element 30. The first signal S1 to the fifth signal S5 are generated by the optical element drive circuit portion 60. The first signal S1 and the third signal S3 have a first pulse wave PW1. The second signal S2 and the fourth signal S4 have a second pulse wave PW2. The first pulse wave PW1 and the second pulse wave PW2 have opposite phases. The fifth signal S5 has a fixed potential P_{fix}. The amplitudes of the first pulse wave PW1, the second pulse wave PW2, and the fixed potential P_{fix} are continuously changed by sliding the first knob 21a of the first slide switch 21. The first signal S1, the second signal S2, and the fifth signal S5 are input to the first terminal 122-1 or the second terminal 122-2 via the changeover switch 23. The third signal S3 and the fourth signal S4 are input to the third terminal 122-3 and the fourth terminal 122-4, respectively.

The changeover switch 23 includes a plurality of input contacts 23in_1, 23in_2, 23in_3, and 23in_4, and a plurality of output contacts 23out_1 and 23out_2. In the changeover switch 23, the output contact 23out_1 is electrically connected to one of the input contacts 23in_1 and 23in_2, and the output contact 23out_2 is electrically connected to one of the input contacts 23in_3 and 23in_4. The electrical connections of the output contacts 23out_1 and 23out_2 in the changeover switch 23 are interlocked. When the output contact 23out_1 is electrically connected to the input contact 23in_1, the output contact 23out_2 is electrically connected to the input contact 23in_3. On the other hand, when the output contact 23out_1 is electrically connected to the input contact 23in_2, the output contact 23out_2 is electrically connected to the input contact 23in_4. Every time the push button 23a of the changeover switch 23 is pressed, the electrical connection between the output contacts 23out_1 and 23out_2 is switched.

As shown in FIG. 7, the first signal S1 and the second signal S2 are input to the input contacts 23in_1 and 23in_3, respectively, and the fifth signal S5 is input to the input contacts 23in_2 and 23in_4.

When the output contacts 23out_1 and 23out_2 are electrically connected to the input contacts 23in_1 and 23in_3, respectively, the first signal S1 and the second signal S2 are input to the first terminal 122-1 and the second terminal 122-2, respectively. Further, the third signal S3 and the fourth signal S4 are input to the third terminal 122-3 and the fourth terminal 122-4, respectively.

In this case, since a lateral electric field is generated between the first transparent electrode 120-1 and the second transparent electrode 120-2, the alignment of the liquid crystal molecules on the first substrate 110-1 side changes. Further, since a lateral electric field is generated between the third transparent electrode 120-3 and the fourth transparent electrode 120-4, the alignment of the liquid crystal molecules on the second substrate 110-2 side changes. Therefore, light passing through the first liquid crystal cell 100-1 is diffused in the x-axis and y-axis directions. Accordingly, the light emitted from the lighting device 1 has a circular light distribution shape diffused in the x-axis and y-axis directions.

When the output contacts 23out_1 and 23out_2 are electrically connected to the input contacts 23in_2 and 23in_4, respectively, the fifth signal S5 is input to the first terminal 122-1 and the second terminal 122-2. Further, the third signal S3 and the fourth signal S4 are input to the third terminal 122-3 and the fourth terminal 122-4, respectively. Therefore, the fixed potential P_{fix} is applied to the first transparent electrode 120-1 and the second transparent electrode 120-2, the first pulse wave PW1 is applied to the third transparent electrode 120-3, and the second pulse wave PW2 is applied to the fourth transparent electrode 120-4.

In this case, since no lateral electric field is generated between the first transparent electrode 120-1 and the second transparent electrode 120-2, the alignment of the liquid crystal molecules on the first substrate 110-1 side does not change. On the other hand, since a lateral electric field is generated between the third transparent electrode 120-3 and the fourth transparent electrode 120-4, the alignment state of the liquid crystal molecules on the second substrate 110-2 side changes. As a result, light passing through the first liquid crystal cell 100-1 is diffused in the x-axis direction. Therefore, the light emitted from the lighting device 1 has a linear light distribution shape which is elongated in the x-axis direction.

The size of the light distribution shape changes depending on the magnitude of the voltage applied to the first transparent electrode 120-1 to the fourth transparent electrode 120-4. In the lighting device 1, the amplitudes of the first pulse wave PW1 and the second pulse wave PW2 input to the first transparent electrode 120-1 to the fourth transparent electrode 120-4 change continuously by sliding the first knob 21a of the first slide switch 21. Therefore, in the lighting device 1, the size of the light distribution shape can be continuously adjusted by sliding the first knob 21a of the first slide switch 21.

As described above, the light distribution shape of the light 1000 irradiated from the lighting unit 10a can be switched using the changeover switch 23 in the lighting device 1. In addition, an elliptical or cross-shaped light distribution shape can also be achieved by changing the combination of the first signal S1 to the fifth signal S5 input to the optical element 30 in the lighting device 1.

### Modification

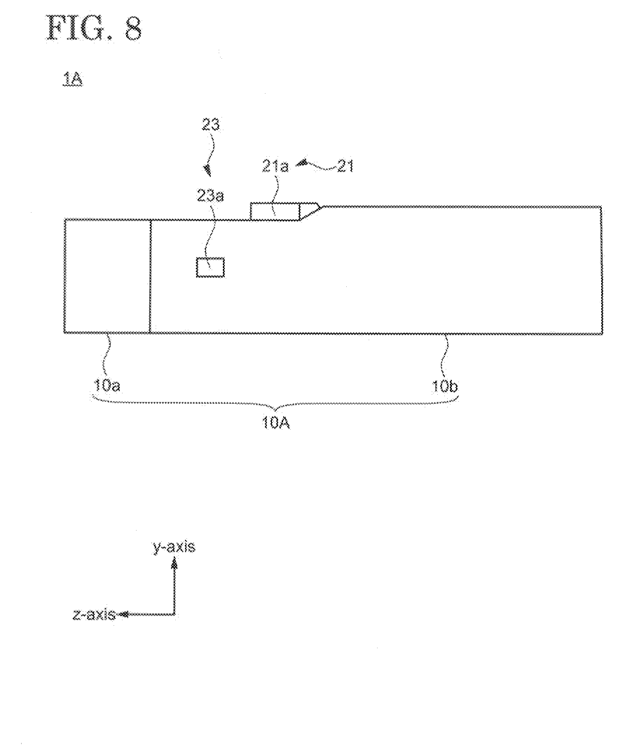

A lighting device 1A, which is one modification of the lighting device 1, is described with reference to FIG. 8. In addition, the modification of the lighting device 1 is not limited to the lighting device 1A. Hereinafter, when a configuration of the lighting device 1A is similar to the configuration of the lighting device 1, the description of the configuration of the lighting device 1A may be omitted.

FIG. 8 is a schematic side view showing an external configuration of the lighting device 1A according to an embodiment of the present invention.

In the lighting device 1A, the lighting unit 10a and the handle unit 10b are connected without bending. That is, the handle axis direction of the handle unit 10b is the same as the optical axis direction. Even when the main body 10 has such a shape, a user can hold the handle unit 10b and slide the first knob 21a of the first slide switch 21 and the second knob 22a of the second slide switch 22 with a finger (e.g., thumb) of the hand holding the handle unit 10b.

As described above, the light distribution and the brightness of the light 1000 irradiated from the lighting unit 10a can be adjusted by a simple operation in the lighting device 1 according to the present embodiment, including the modification. In other words, the light distribution and the brightness can be easily adjusted in the lighting device 1. Further, since the light distribution angle and the brightness of the light 1000 change continuously, the user can fine-tune the light distribution angle and the brightness of the light 1000.

Within the scope of the present invention, those skilled in the art may conceive of examples of changes and modifications, and it is understood that these examples of changes and modifications are also included within the scope of the present invention. For example, additions, deletions, or design changes of constituent elements, or additions, omissions, or changes to conditions of steps as appropriate based on the respective embodiments described above are also included within the scope of the present invention as long as the gist of the present invention is provided.

Further, other effects which differ from those brought about by each embodiment, but which are apparent from the description herein or which can be readily predicted by those skilled in the art, are naturally understood to be brought about by the present invention.

What is claimed is:

1. A lighting device, comprising:
a light source;
an optical element comprising a liquid crystal cell and transmitting light emitted from the light source in a diffusible manner;
a main body incorporating the light source and the optical element and irradiating the light that passes through the optical element; and
a first slide switch comprising a first knob that is slidably operated relative to the main body and that adjusts a light distribution angle of the light irradiated from the main body by sliding the first knob.

2. The lighting device according to claim 1,
wherein the first slide switch is connected to the optical element, and
wherein a magnitude of a voltage applied to a transparent electrode in the liquid crystal cell is continuously changed by sliding the first knob.

3. The lighting device according to claim 1, further comprising a second slide switch comprising a second knob that is slidably operated relative to the main body and that adjusts a brightness of the light irradiated from the main body by sliding the second knob.

4. The lighting device according to claim 3,
wherein the second slide switch is connected to the light source, and
wherein an amount of current supplied to the light source is continuously changed by sliding the first knob.

5. The lighting device according to claim 1,
wherein the main body comprises:
a lighting unit irradiating the light, and
a handle unit on which the first knob is mounded, connected to the lighting unit,
wherein an optical axis direction of the light irradiated from the lighting unit is different from a handle axis direction along which the handle unit extends.

6. The lighting device according to claim 1,
wherein the main body comprises:
a lighting unit irradiating the light, and
a handle unit on which the first knob is mounded, connected to the lighting unit,
wherein an optical axis direction of the light irradiated from the lighting unit is a same as a handle axis direction along which the handle unit extends.

7. The lighting device according to claim 5, wherein the first knob is slidable in the handle axis direction.

8. The lighting device according to claim 1, further comprising a second slide switch comprising a second knob that is slidably operated relative to the main body and that adjusts a brightness of the light irradiated from the main body by sliding the second knob,
wherein the main body comprises:
a lighting unit irradiating the light, and
a handle unit on which the first knob and the second knob are mounded, connected to the lighting unit, and
wherein the first knob and the second knob are arranged along a direction intersecting a handle axis direction along which the handle unit extends.

9. The lighting device according to claim 1, further comprising a changeover switch connected to the optical element and changing a light distribution shape of the light irradiated from the main body.
